(19) United States
(12) Patent Application Publication
(10) Pub. No.: US 2003/0195778 A1
(43) Pub. Date: Oct. 16, 2003

(54) Intelligent authorized return systems and methods

(75) Inventor: William Loyd Smith, Roswell, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: UNITED PARCEL SERVICE OF AMERICA, INC.

(21) Appl. No.: 10/177,508

(22) Filed: Jun. 20, 2002

Related U.S. Application Data
(63) Continuation-in-part of application No. 10/123,066, filed on Apr. 11, 2002.

(51) Int. Cl. G06F 17/60

(52) U.S. Cl. 705/7

(57) ABSTRACT

The present invention discloses systems and methods for the provision of shipping labels for use in returning parts distributed to field service technicians. A system is disclosed that processes a service parts order request against one or more rules and generates return shipping labels that are printed and enclosed in packages with service parts. Field service technicians use the appropriate return shipping label to identify the status of the service part and insure the timely return of both used and unused service parts to a facility equipped to handle them.

### CROSS REFERENCE TO RELATED APPLICATIONS

This application is a continuation-in-part of copending U.S. patent application Ser. No. 10/123,066, filed on Apr. 11, 2002, which is hereby incorporated herein in its entirety by reference.

### FIELD OF THE INVENTION

The present invention relates to the field of reverse logistics. Specifically, the present invention is a system and method to provide shipping labels to field service technicians for use in returning service parts.

### BACKGROUND OF THE INVENTION

The trend in the manufacture of high tech equipment is towards the assembly of modular components from multiple, external suppliers. As a result of this trend, field service technicians, those individuals charged with post-sale servicing and repairing of these products, generally focus more on diagnosis-and-replacement rather than diagnosis-and-repair. In fact, if a problem originates in a modular component that was sourced from a third-party supplier, the component may not be amenable to on-site repair by either the manufacturer or its repair staff.

Much of the efficiency of the modern-day field service technician thus depends on having the correct replacement part on hand when a problem arises. Any economies and efficiencies in post-sale servicing are either compromised or lost if a technician has to make multiple trips to a site to make a repair. Thus, it is generally more efficient for a field service technician to take extra service parts to a repair site than to have the technician make a first trip to diagnose the problem and a second trip to bring the parts to fix it.

There are, however, drawbacks to sending a field service technician to a repair site equipped with a varied selection of spare parts. One drawback is the difficulty inherent in tracking and managing service part inventory levels when there is little indication as to which service parts will actually be used in a repair. For any given repair, some or all of the service parts that a technician takes to a site may not be used in the repair. These parts, then, are shipped back to a service parts warehouse or other storage facility where they are made available for the next service call.

For purposes of example, an exemplary service call is illustrated in FIG. 1. In Step 1, a field service technician is notified of a service call and receives a written or oral description of the problem. In Step 2, the technician makes a preliminary diagnosis of the problem based upon the written or oral description the technician has received, and in Step 3, the technician orders multiple service parts, based upon the technician's initial impression of what may be needed.

Service parts are typically warehoused in either a distribution center or a field stocking location. There are generally many more field stocking locations than distribution centers; therefore, if a field technician needs a part immediately, the part is generally ordered from a field stocking location, whereas service part orders that are less time sensitive are generally filled from a distribution center.

In Step 4, the service parts that the field service technician ordered in Step 3 are sent to a carrier pickup site in what is known as a “hold for pickup” process. Depending on whether the service parts were ordered from a field stocking location or a distribution center, the parts arrive at the carrier pickup site anywhere from a few hours to several days after they were ordered. In Step 5, the field service technician picks up the service parts. In the past, a field service technician could only pick up service parts during normal business hours; however, in recent years, carriers such as the United Parcel Service of America, Inc. have offered hold for pickup services that allow a service technician to pickup parts around the clock.

In the “hold for pickup” process, a manufacturer has field technicians to repair equipment spread across various locales, and these technicians often have an immediate need for repair parts from a stocking location or distribution center. If the manufacturer requests ordinary overnight delivery of the package containing a part, the technician will not receive the repair part until late morning. Although early morning delivery options are sometimes available, they often are too expensive for the manufacturer to use on a regular basis. In the hold for pickup process, the manufacturer requests that the package be held at the carrier's consolidation point nearest to the job site for personal pickup by the technician early in the morning. This procedure has the dual benefit of early receipt of the package and low cost, because the final delivery by small vehicle from the carrier's facility to the consignee is an expensive part of the package transportation process.

In Step 6, the field service technician has picked up the parts and takes them to the repair site where the technician completes the needed repair. For purposes of this example, we will assume that the field service technician ordered five parts for the repair and used three of the parts in making the repair. In addition, in this example we will assume that one of the parts that was replaced remains under warranty and needs to be returned to the manufacturer or to a component part manufacturer for repair. Thus, in this illustration, after the repair is completed the field service technician has two “new” parts that were never used and a “used” part that needs to be repaired.

To further complicate the situation, the field technician has between eight and ten repair problems to address each day. As a result, it is not unusual for a field service technician to store the spare and used parts in a repair truck or van for two or more weeks until the technician has an opportunity to ship the parts back for re-shelving and/or repair (Step 7).

In Step 8, the field service technician ships the spare parts back for re-shelving and ships the used part back to be repaired. As known in the art, it is not unusual for a field service technician to spend an entire day each week sorting through parts to determine which parts are associated with which repairs and where to return the parts. In some cases, unused service parts may be kept in a repair truck for two or more weeks until the technician has the opportunity to sort through and ship the parts back to the various distribution centers and field stocking locations.

Under the above-described process, several significant problems have been noted, which are discussed as follows. The delay in the return of unused parts results in inefficient and inaccurate product inventory management. At any given moment, a company may have several million dollars worth of unused service parts sitting in repair trucks or in route to the distribution centers and field stocking locations from technicians that have held the parts for varying lengths of time. Because the company does not know which service parts were used in the repair and which will ultimately be returned for re-shelving the company faces parts inventory management problems.

Another problem associated with the aforementioned process is a significant delay in billing. In the illustration above, the field service technician ordered five parts for the repair, but only used three of the five parts in making the repair. Typically, the company cannot bill its customer for the repair until the service parts are returned and the company determines which of the parts were used in the repair. Thus, customer-billing cycles known in the art are generally delayed while the company and field service technicians determine which parts were used in a repair and which were re-shelved.

Still another problem illustrated by the foregoing example is the handling of used parts. In some cases, a service technician will ship a part that has been replaced as part of a warranty process, in other cases the value of the part justifies its repair. The used-part problem often arises at the distribution centers and the field stocking locations when a part arrives without instructions from the field technician as to whether the part is to be re-shelved or sent for repair. In some warehouses, companies have established intricate testing operations to determine whether the parts that are received from their field technicians are in need of repair. These often-manual testing operations are both costly and prone to error.

Thus, an unsatisfied need exists in the industry for an improved service parts returns system that that overcomes deficiencies in the prior art, some of which are discussed above.

### BRIEF DESCRIPTION OF THE DRAWINGS

Having thus described the invention in general terms, reference will now be made to the accompanying drawings, which are not necessarily drawn to scale, and wherein:

FIG. 1 is a process flow diagram of a service call as is known in the art.

FIG. 2 is a high-level block diagram of a service parts return system according to an embodiment of the present invention.

FIG. 3A-3C are typical reports that are available to users of a service parts return system according to an embodiment of the present invention.

FIG. 4 illustrates the distributed application architecture of a service parts return system according to an embodiment of the present invention.

FIG. 5 is a high-level process flow of a service parts return system according to an embodiment of the present invention.

FIG. 6 is a process flow diagram that illustrates the steps involved in processing a service parts order according to an embodiment of the present invention.

FIG. 7 is a process flow diagram that illustrates how a stored procedure is invoked during the processing of a service parts order according to an embodiment of the present invention.

FIG. 8 is a process flow diagram that illustrates the application of rules against a service parts order according to an embodiment of the present invention.

FIG. 9 is a process flow diagram of a retrieval and pre-processing operation according to an embodiment of the present invention.

FIG. 10 is a process flow diagram that illustrates the invocation of an enterprise java bean client according to an embodiment of the present invention.

FIG. 11 is a process flow diagram that illustrates the application of rules to a service parts order according to an embodiment of the present invention.

FIG. 12 is a process flow diagram that illustrates the process of receiving and processing a service parts order object/data in preparation for an update of a database according to an embodiment of the present invention.

FIG. 13 is a process flow diagram that illustrates the process of updating an order database according to an embodiment of the present invention.

FIG. 14 is a process flow diagram that illustrates the pick and ship steps of the service parts order processing operation according to an embodiment of the present invention.

FIG. 15 is a process flow diagram that illustrates a shipping label print operation according to an embodiment of the present invention.

FIG. 16 is another process flow diagram of a shipping label print operation according to an embodiment of the present invention.

FIG. 17 is a process flow diagram that illustrates the creation of a printer drop file according to an embodiment of the present invention.

FIG. 18 illustrates a service parts return shipping label according to an embodiment of the present invention.

FIG. 19 illustrates another service parts return shipping label according to an embodiment of the present invention.

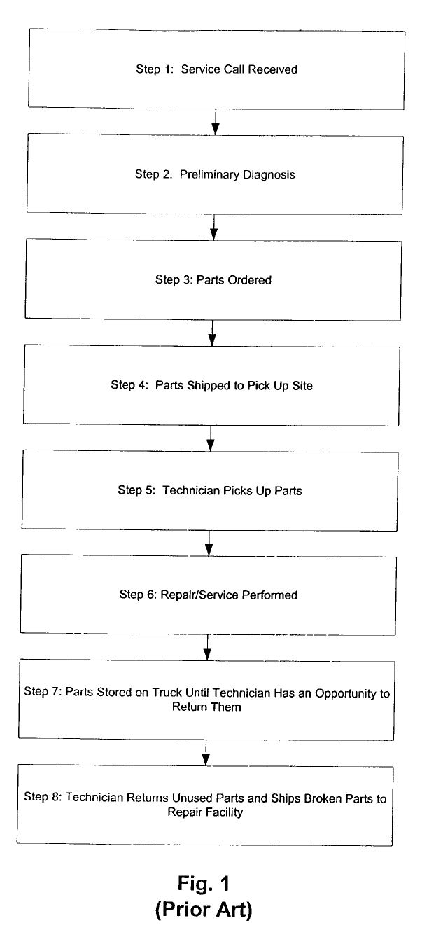

### SUMMARY OF THE INVENTION

The present invention discloses systems and methods for the provision of shipping labels for use in returning parts distributed to field service technicians. A system is disclosed that processes a service parts order request against one or more rules and generates return shipping labels that are printed and enclosed in packages with service parts. Field service technicians use the appropriate return shipping label to identify the status of the service part and insure the timely return of both used and unused service parts to a facility equipped to handle them.

In accordance with an embodiment of the present invention, a method of providing service parts to a field technician is described that includes the steps of receiving an order to ship a part to a field technician, the order including a part identifier associated with the part; querying a parts database with the part identifier to identify a warehouse that the said part in stock; processing the order against a rules engine to associate an outbound shipping label and one or more return shipping labels to the order, and to generate shipping label data for the outbound shipping label and for the one or more return shipping labels; printing the outbound shipping label and the one or more return shipping labels at the warehouse; enclosing the one or more return shipping labels in a package with the part; affixing the outbound shipping label to the package; and shipping the package to the field technician.

In another related embodiment, the method is described wherein the step of querying a parts database to identify a warehouse includes querying a parts database to determine whether the part is available and, if available, where the part is located. In another embodiment, the step of querying a parts database to identify a warehouse includes the steps of identifying a warehouse that has the part in stock; setting a flag in the parts database to reserve the part; and contacting the warehouse to have the part picked for shipment. In still another embodiment, the step of querying a parts database to identify a warehouse includes querying a parts database to determine whether the part is available and, if not available, backordering the part. In yet another disclosed embodiment, the step of processing the order against a rules engine includes the steps of converting the order into an order array for submission to an enterprise Java bean via an enterprise Java bean client; receiving the order array into the enterprise Java bean; creating a Java order object suitable for processing by the rules engine; and passing the order object to the rules engine.

In another related embodiment, the method is described wherein the step of generating shipping label data for one or more return shipping labels includes generating label data for a first and second return shipping label, the first return shipping label identifying a returned part as used, and the second return shipping label identifying the returned part as unused. In another embodiment, the step of generating shipping label data for one or more return shipping labels includes generating data for shipping labels that allow the field technician to ship a used part for at least one of repair, restocking, salvage and disposal. In still another described embodiment, the step of printing the outbound label and the one or more return shipping labels at the warehouse includes transmitting the shipping label data in an electronic format to a printing device located at the warehouse; and printing the outbound label and the one or more return shipping labels on the printing device, wherein the information printed on the shipping labels is based at least in part on the shipping label data. In yet another embodiment, the step of printing the outbound label and the one or more return shipping labels at the warehouse includes transmitting the shipping label data in an electronic format to a computer system associated with the warehouse; forwarding the shipping label data to a carrier application upon a manual activation of the warehouse computer system; assigning a package tracking number to the outbound shipping label and each of the one or more shipping labels; generating the outbound shipping label and the one or more shipping labels based at least in part on the shipping label data; and printing the outbound shipping label and the one or more shipping labels at the warehouse.

In another disclosed embodiment, the method described above also includes the step of assigning a package tracking number to the outbound shipping label and to each of the one or more return shipping labels. And in another related embodiment, the step of enclosing the one or more return shipping labels in a package with the part includes the steps of picking the part from a storage area within the warehouse; placing the part in a package; retrieving the one or more return shipping labels from a printing device; and enclosing the one or more return shipping labels in the package.

In accordance with another embodiment of the present invention, a service parts shipping system is described that includes an order entry application, the order entry application configured to receive order data from a user, the order data including at least one service part number; a parts management application in electronic communication with the order entry application, the parts management application configured to receive the order data and query a parts database with the service part number to determine an availability of a service part; a rules engine in electronic communication with at least one of the order entry system and the parts management application, the rules engine configured to receive the order data and process the order data against one or more rules; the rules engine further configured to generate shipping label data based at least in part on the one or more rules; and a printing device configured to print at least one shipping label based at least in part on the shipping label data.

In another related embodiment, the parts management application is further configured to identify a warehouse that has the service part in stock. In additional embodiments, the parts management application is further configured to reserve the service part and backorder a service part that is unavailable. In still another described embodiment, the rules engine is configured to process the order data against at least one of a carrier rule, a logistics rule and a user-defined rule. In another embodiment, the rules engine is configured to generate shipping label data for an outbound shipping label and a return shipping label.

In another embodiment, the system is described such that the rules engine is configured to generate shipping label data for a first and second return shipping label, the first return shipping label identifying a returned part as used, and the second return shipping label identifying the returned part as unused. In still another embodiment, the rules engine is configured to generate shipping label data for return shipping labels that allow a field technician to ship a used part for at least one of repair, restocking, salvage and disposal.

In still another embodiment, the system is described to further include a warehouse application, the warehouse application configured to receive the shipping label data, the warehouse application further configured to transmits the shipping label data to a carrier system and receive a shipping label image from the carrier system; and a shipping label generation application residing on the carrier system, the shipping label generation application configured to receive the shipping label data and generate the shipping label image. In yet another embodiment, the shipping label application is further configured to transmit the shipping label image to the printing device, and the shipping label printed by the printing device is based at least in part on the shipping label image.

In accordance with another embodiment of the present invention, a method of monitoring the status of service parts that are shipped to a field technician is disclosed that includes the steps of receiving a service parts request, the service parts request including a request to ship a service part to a field technician; generating an outbound shipping label and a return shipping label in response to the service parts request; assigning a first service part tracking number to the outbound shipping label and a second service part tracking number to the return shipping label; storing information about the service parts request in a service parts transaction database, the stored information including the first and second service part tracking numbers; capturing package level detail information about a package that is shipped through a carrier, the package level detail information including a package shipment status and a package tracking number associated with the package; and updating the service parts transaction database with the package level detail information when the package tracking number corresponds to the first or second service parts tracking numbers.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

The following paragraphs describe a service parts return system 10 in accordance with an embodiment of the present invention, the function of which is the provision of shipping labels for use in returning parts distributed to field service technicians.

In general, service parts are picked, packed and shipped from distribution centers and/or field stocking locations to the field service technicians who may or may not use the parts to effect repairs on products. The service parts arrive to the field technicians accompanied by one or more shipping labels, which the field technician will use to return unused service parts or, in some cases, used parts from a repair that needs to be returned. Typically at least two shipping labels are provided, one for the return of a new or unused part, and the other for the return of a used part. The return location for the service parts can vary based on a variety of order or part attributes. Used parts may or may not be returned at all. Used parts that are returned are preferably sent to a location equipped to refurbish, salvage and/or safely dispose of the part. An unused part may be returned to a distribution facility or field stocking location from which it was shipped, a warehouse experiencing a shortage of that part, or to a central location for later redistribution.

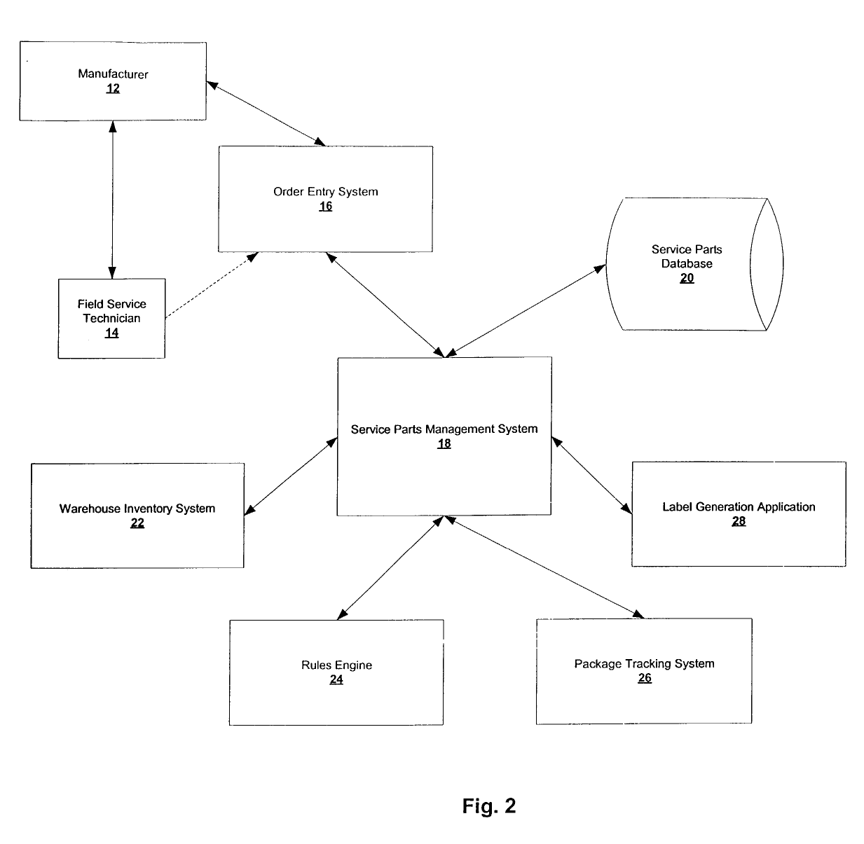

FIG. 2 is a high-level block diagram of the components of one embodiment of a service parts return system 10. In this embodiment, a manufacturer 12 of a product employs one or more field service technicians 14 to service the product. When the manufacturer 12 receives a request for service, the manufacturer 12 contacts a field service technician 14 with a description of the problem. The field service technician 14 makes an initial diagnosis of the problem and sends the manufacturer 12 a service part list that may be required to effect the repair.

Upon receipt of the service parts list, the manufacturer 12 uses an order entry system 16 to have the service parts shipped to the field service technician 14. The order entry system 16 may be a component of a manufacturer computer network in which case the manufacturer 12 inputs the service parts information into the order system 16. Alternatively, the order entry system 16 may be at a remote location and service multiple manufacturers. In this alternative embodiment, the manufacturer 12 sends the service parts list to the order entry system 16 by any of several means that are well known in the art, including electronic data interchange (EDI), email, facsimile or via a phone call to a customer service representative that inputs requests into the order system 16. In still another embodiment, shown in FIG. 2 with a broken line, the field service technician 14 communicates the service parts list directly to the order entry system 16.

Once the service parts list is entered into the order entry system 16, the parts list is transmitted to a service parts management system 18. The service parts management system 18 queries a service parts database 20 to determine whether the requested service parts are available and, if available, where the requested parts are located. When the service parts management system 18 finds that the requested parts are available, a flag is set in the service parts database 20 to reserve the part. Information about the availability and location of the requested service parts is to the manufacturer 12 and/or field service technician 14 via the order entry system 16.

If the user is satisfied with the availability and location of the service parts, an order is placed in the order entry system 16 and the service parts are pulled from their stocking locations and prepped for shipment. The order is transmitted to the service parts management system 18 and the service parts database 20 is updated to reflect that the requested service parts are being shipped to the field service technician 14.

In an alternative embodiment, the order process is not a two-step process in which part availability is checked before the order is entered. Instead, when the service parts list is entered, an order is created and sent to the service parts management system 18. The parts referenced in the order are then checked against the service parts database 20 and reserved for the order. If a part is unavailable the parts are either backordered or a search is made of supplier systems to have the part drop-shipped from the supplier to the field service technician 14.

Once a service order is placed, the service parts management system 18 contacts the warehouse inventory systems 22 of the distribution centers and/or field stocking facilities that are supplying the requested service parts. Multiple distribution centers and field stocking locations may be involved in a single service parts order and each of the locations can have different warehouse inventory systems 22. In one embodiment of the present invention, the service parts order that is sent from the service parts management system 18 to the warehouse inventory system 22 is sent electronically and the same format is used in every warehouse system 22. In an alternative embodiment, different warehouse systems 22 require different formats for service part orders and the service management parts system 18 is configured to provide service part orders in different formats.

The service parts management system 18 then processes the service parts order against a rules engine 24. The operation of processing an order against the rules engine 24 is described in greater detail below. In general, the rules determine whether and which service parts shipping labels will be generated for each of the requested service parts. In addition, several of the fields on the shipping label are user-definable and the rules determine the data that will populate these fields.

In a preferred embodiment, the rules processing occurs when a service part is picked. Shipping label information is output from the rules process and is stored in a shipping label table. In general, the shipping label information includes service parts return shipping label information for shipping labels that are packaged along with the service parts and used by field service technicians 14 to ship service parts back to the warehouse. Moreover, information for an outbound shipping label that is used to ship the parts to the field service technician 14 can be included in the shipping label table.

Updates to the rules engine 24 occur via a development workstation or via a maintenance application. A developer uses a rules development workstation to add or modify rules in the engine 24. As modifications are made through the development workstation they are immediately stored in the master or production version of the rules engine 24. In contrast, additions, deletions or modifications to the rules engine 24 made by non-developers are first stored in a quality control or test version of the rules engine 24 before they are moved into production. Whereas developers use a developer workstation to effect changes in the rules, non-developers use the rules maintenance application which, in a preferred embodiment, includes a more user-friendly graphic interface than its developer counterpart.

After the rules processing is completed and the service parts are picked and packaged for shipment to the field service technician 14, a warehouse employee initiates the next step by indicating that the parts are ready for shipment. In a preferred embodiment, the employee will activate a ship function on a warehouse application to initiate the following shipping processes.

Upon activation of the shipment function, the shipping label information is sent to a package tracking system 26 where a package tracking number is assigned to each label. Package tracking numbers are well known in the art and comprise a unique identifier that allows parties to a transaction to track a shipment in a carrier system from pickup to delivery. In a preferred embodiment, a unique package tracking number is assigned to each shipping label and a package tracking database is updated accordingly.

Upon assignment of package tracking numbers, the service parts management system 18 passes the shipping information for each shipping label to a label generation application 28, which generates the requested shipping labels. The shipping labels are then transmitted to the appropriate distribution centers and/or field stocking locations where they are printed and included in the package containing the service parts to be shipped to the field service technician 14. In one embodiment, the shipping labels transmitted to the distribution centers and/or field stocking locations include the shipping label(s) required to ship the service parts package(s) to the field service technician. In addition, shipping labels are transmitted that will be used by the field service technician 14 to return used and unused service parts and these return shipping labels are included in the package containing the service parts.

In a preferred embodiment, the service parts management system 18 generates detailed information about the service parts that are being shipped and uploads this information to the package carrier. This information may include for example, the origination and destination addresses of the package, the size and weight of the package and the method and/or service level of the shipment. One of ordinary skill in the art will readily recognize that additional information about the shipment of the package is captured and uploaded in this step of the process. In one embodiment, a package carrier operates the service part returns system 10 and assumes responsibility for picking up the service parts from the various distribution centers and field stocking locations and delivering the parts to the field service technician. In an alternative embodiment, a service part returns system 10 may serve multiple carriers and the service part order may specify one of several package carriers. In still other embodiments, different package carriers may be used to deliver different service parts within a single service part order. For purposes of illustration, however, the following paragraphs describe a service part return system 10 in which a single package carrier is used for service part package shipping.

In a preferred embodiment, a package carrier receives the service part shipping detail and sends carrier drivers to the various distribution centers and field stocking locations specified in the shipping detail to pick up the service parts requested by the field service technician 14. In this embodiment, the packages that contain the service parts also include the one or more return shipping labels that were generated as described above.

In the next step, the package carrier delivers the packages containing the service parts to the field service technician 14. In a preferred embodiment, packages containing the service parts requested by the field service technician 14 are sent from a plurality of locations. Accordingly, the packages are sent to a local carrier facility and held there until the field service technician picks them up. In a preferred embodiment, the service part packages that are sent to the field service technician 14 are sent using a hold-for-pickup service such as is known in the art. With this service, as the packages containing service parts arrive at the destination carrier facility they are set aside and held for the field service technician 14 instead of being processed further through the carrier system. As is known in the art, a benefit of this service is that the field service technician 14 has earlier access to the packages that contain the service parts and can proceed immediately to the service call.

For purposes of illustration, assume that a field service technician 14 orders and receives five service parts for a given service call. In this example, the technician 14 uses three of the five parts to effect the repair and, in addition, obtains one used part from the product repaired. When the technician 14 opens the packages containing the service parts, the technician 14 retrieves the service part and the one or more return shipping labels that were packaged along with each service part.

In this example, three of the five service parts that were sent to the field technician 14 are used to repair the product and will not be returned. Two unused service parts and one used part will be returned. In a preferred embodiment, two return shipping labels are included with each of the two unused service parts. The first of the two return shipping labels indicates that the service part has not been used and has a destination address of a distribution center, field stocking location or other location that is equipped to receive and restock the service part. The second return shipping label indicates that the service part has been used and/or is defective. The destination address of the second return shipping label will typically be a facility equipped to refurbish, salvage or dispose of the used part.

With regard to the two service parts that were not used in the repair, the field service technician 14 repackages the service part and affixes the return shipping label that identifies the part as unused. Alternatively, if during the repair the service technician 14 discovered that one or both of the service parts were defective the technician 14 would affix the return shipping label that identifies the part as used to prevent a defective part from being re-shelved. In still another embodiment, a third return shipping label is available to the technician 14 that identifies the part as not having been used in the repair but nevertheless defective. The destination address of the third return shipping label can be the same destination as that of used parts or, alternatively, service parts identified as defective are returned to the entity that supplied the defective part.

The field service technician 14 also uses return shipping labels to return the used part obtained during the repair. If the used part is replaced by one of the service parts that were shipped to the technician 14, the return shipping label enclosed with the replacement service part that identifies the part as used is affixed to the package containing the used part. In an alternative embodiment, additional return shipping labels may be provided to the technician 14 for any part under warranty. Thus, in the alternative embodiment, if a service technician 14 determines that a used part is under warranty, a return shipping label that identifies the good as a warranty return is affixed to the package containing the used part.

Once the field service technician 14 has repackaged the service parts to be returned and affixed the appropriate labels, the packages are delivered to a package carrier. In a preferred embodiment, the package carrier used for the return service part shipment is the same carrier used to ship the service parts to the technician 14. In an alternative embodiment, however, the field service technician 14 can choose from several package carriers for a return shipment. However, if a choice of package carriers is available, the choice should be made prior to the various return shipping labels being generated as different package carriers use different shipping label formats.

The return shipping labels on the packages containing the service parts are scanned when the package carrier accepts the return package. Return shipping information is then sent to a central storage facility of the package carrier. In a preferred embodiment, the return shipping labels for the service part packages indicate that the packages are associated with the service part return system 10. Accordingly, the return shipping information is transmitted to the service parts management system 18 whenever a service parts return package is scanned.

The service parts management system 18 receives the shipping information for the return service part packages and forwards the information to the manufacturer 12. In a preferred embodiment, batches of shipping information are transmitted to manufacturers 12 at predetermined times during a day. One of ordinary skill in the art will readily recognize however that shipping information may be transmitted many different ways according to the needs or at the request of a manufacturer 12. Because multiple manufacturers 12 can participate in the service parts return system 10, the service parts management system 18 transmits only that shipping information that associated with a given manufacturer

In a preferred embodiment, the package carrier scan of the return shipping label captures sufficient information about the package that the manufacturer 12 can identify the service part contained within the package and the status of that part. Thus, the return shipping information provided by the package carrier to the manufacturer 12 identifies the service parts that are inbound and the status and destination of each part. And this enhanced visibility into the package shipping system provides the manufacturer 12 with greater accuracy in forecasting its service part inventory. In a preferred embodiment, a package carrier scans every package that is in transit in its system and identifies those packages that contain service parts by comparing the package tracking number against the package tracking numbers that were assigned to service part shipping labels and associated outbound shipping labels. The service part tracking numbers may be stored, for example, in a service parts transaction database, along with other information about the associated service order.

Another benefit of this greater visibility is the elimination of delays in billing for the repair. In the processes known in the art, service charges are often delayed several weeks until the manufacturer 12 receives the used and unused service parts and determines which of the parts originally ordered by the field service technician 14 were used in the repair. The present invention eliminates these delays by notifying the manufacturer 12 of the service parts that are in transit to its distribution centers and/or field stocking locations.

Still another benefit of this process is the accumulation of historical data about the movement of service parts between warehouses and field service technicians 14. As will be readily apparent to one of ordinary skill in the art, a variety of reports can be generated from this historical data that will provide valuable tools to manufacturers 12. In a preferred embodiment, the service parts management system 18 includes a reports-generation feature that provides manufacturers 12 and other users customizable reports about service parts movement.

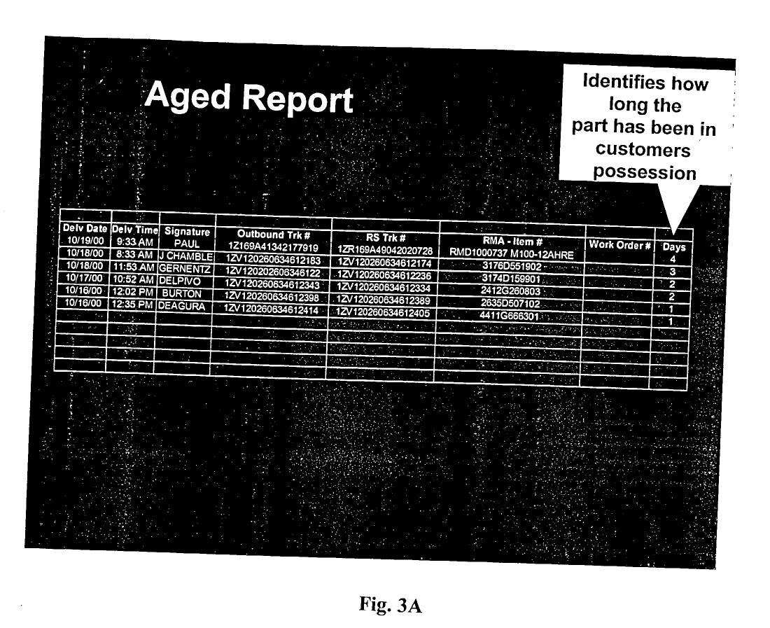

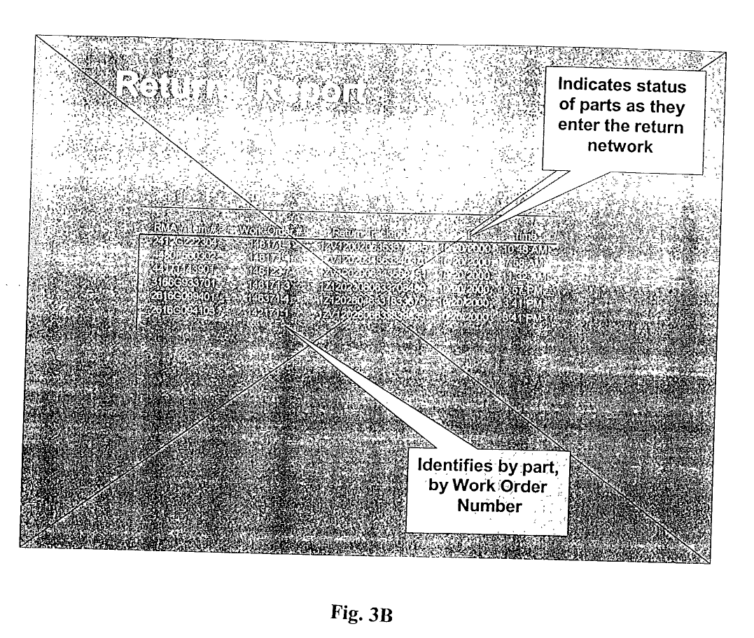

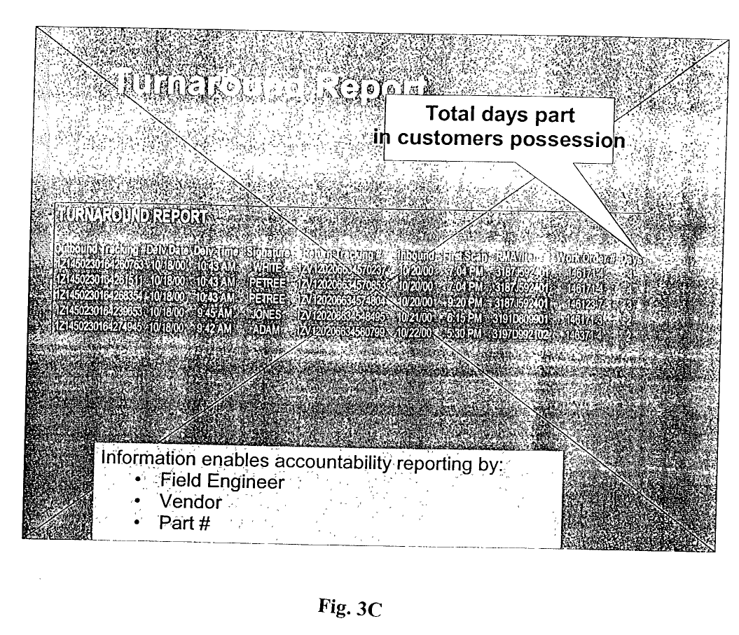

In one embodiment, specific reports are available to users of the system 10. In an alternative embodiment, some or all of the users have access to a service parts transaction database 30 that includes the historical data associated with each user. User access to the transaction database 30 allows users to formulate their own queries and generate custom reports. Some of the reports available to users are illustrated in FIGS. 3A-3C and include an Aged Report, a Returns Report, and a Turnaround Report. One of ordinary skill in the art will readily recognize that additional reporting capabilities are provider to users having access to the transaction database 30.

The following paragraphs provide additional detail about the system architecture of an embodiment of the present invention.

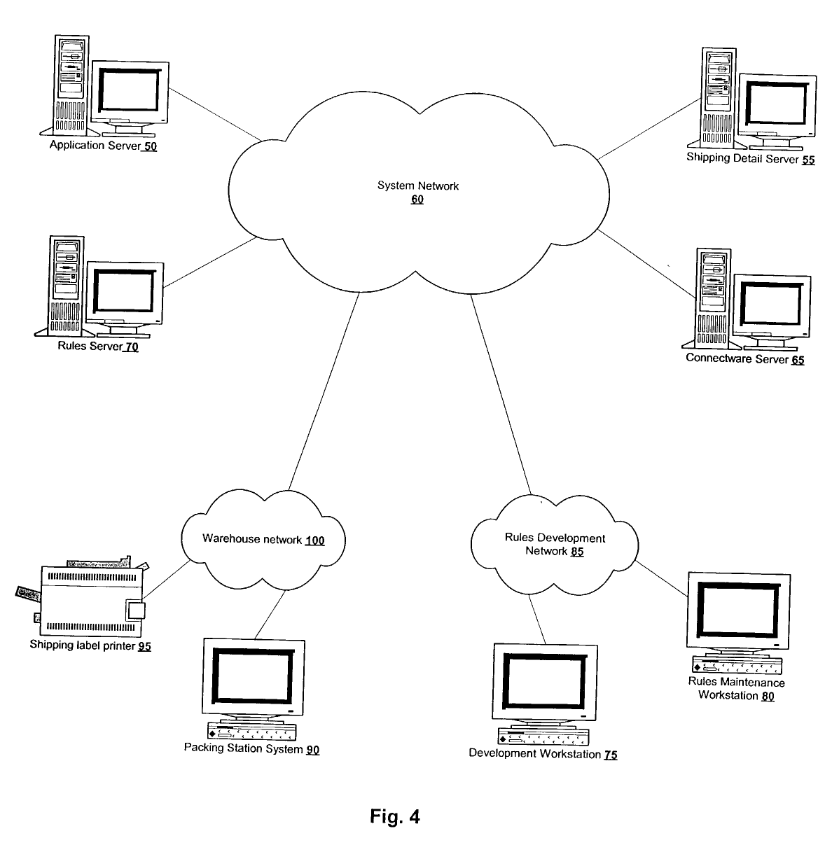

FIG. 4 illustrates the distributed application architecture of a service parts return system 10 in accordance with another embodiment of the present invention. In this figure, an application server 50 is represented as a single system; however, one of ordinary skill in the art will readily recognize that this server may be physically instantiated as a collection of servers with components distributed for scalability and redundancy. In a preferred embodiment, the application server 50 supports the Oracle relational database management system (RDBMS) though one of ordinary skill will recognize that the present invention is equally advantageous with other database systems known in the art.

A carrier shipping system 55 communicates with the application server 50 via the network 60. In a preferred embodiment, the network 60 is an Ethernet network; however, other networks known in the art can be used as well. The carrier shipping system 55 generates package tracking numbers and the associated shipping data for the system and is responsible for uploading shipper end of day data to associated shipper host systems. In a preferred embodiment, communication with the carrier shipping system 55 occurs via a message queue series interface (MQSI) running over a MQSeries as is known in the art.

A warehouse management server 65 communicates with both the application and carrier shipping system 55 via the network 60. Again, while represented as a single server, the warehouse management server 65 may be physically instantiated as a collection of servers with components distributed for scalability and redundancy. In a preferred embodiment, the warehouse management server 65 provides RF extensions to an Oracle enterprise resource planning system (ERP) and provides warehouse functionality. In operation, the warehouse management server 65 receives service parts order data from the application server 50 and exchanges shipping data with the carrier shipping system 55 via MQSI.

An ARS server 70 also communicates over the network 60 and hosts the rules engine 24 that determines which, if any, shipping labels are generated by the system 10. In a preferred embodiment, the ARS server 70 deploys the rules engine 24 via an enterprise Java bean (EJB). Enterprise beans provide rules processing to the service part order data passed to the bean.

The developer workstation 75 and rules maintenance workstation 80 are interfaces that allow developers and other users to add, modify and/or delete rules. In a preferred embodiment, the rules maintenance workstation 80 is used primarily by non-technical users and, accordingly, greater limitations are placed on the modifications made to rules by these workstations. For example, in a preferred embodiment the criteria by which a rule is executed can be changed via a rules maintenance workstation 80, but not the fundamental structure of the rule.

In a preferred embodiment, the developer workstation 75 and rules maintenance workstation 80 communicate with the system network 60 and other system components via a rules development network 85. In a preferred embodiment, the rules development network 85 is an Ethernet network. But it will be readily apparent that other types of networks known in the art can be used with the present invention.

Packout stations 90 and label printers 95 are connected to the system network 60 via a warehouse network 100. In a preferred embodiment, the warehouse network is an Ethernet network, but again other networks known in the art will provide the same functionality. The packout stations 90 represented in FIG. 4 provide the warehouse systems use by the distribution centers and field stocking locations. In a preferred embodiment, these systems represent a presentation only layer with browser-based connectivity to the other system servers, including the application server 50 and the warehouse management server 65. The label printers 95 are the printers on which the shipping labels are printed. In a preferred embodiment, Eltron printers are used and provide label printing capabilities to support both outbound and service parts return shipping labels. A jet form server 105 (not shown) is also present to manage the print queues that enable the printing of shipping labels. In a preferred embodiment, shipping label drop files are recognized by the jet form server 105 and interpreted for the label printers 95 that renders the label that contains the data.

The following paragraphs describe the operation of a service parts return system in accordance with an embodiment of the present invention. The description is presented in a drill-down format in which greater detail is provided in succeeding paragraphs and associated figures.

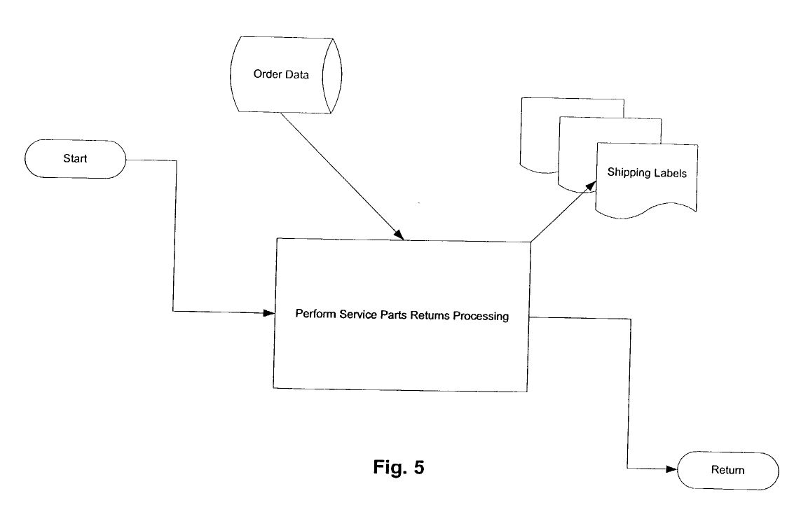

FIG. 5 illustrates the highest-level process flow of a service parts return system 10. At a high level, the function of the system is to receive an service parts order from a user and produce one or more outbound and/or service parts return shipping labels associated with the order.

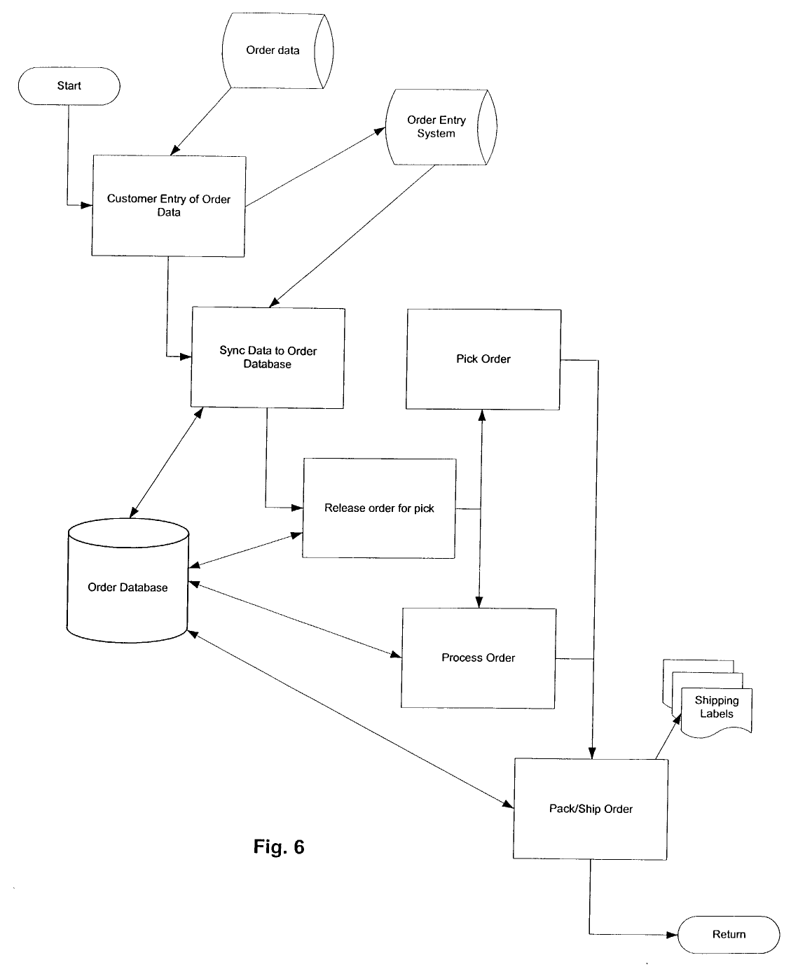

FIG. 6 illustrates a first drill-down into the process. The processing lifecycle is the order itself. The process illustrated initiates with the input of a service parts order. Typically a field service technician 14 diagnoses a repair problem and orders the service parts that the technician believes may be associated with the problem. Order data may be entered by any of the field service technician 14, a manufacturer 12 or a customer service representative acting as a user of an order entry system 16. Order data entry is via the web, EDI or manual entry.

Upon entry, order data is replicated to an instance of Oracle. Again, Oracle is represented herein for illustrative purposes as Oracle is a well known database and application development software vendor. The present invention is equally advantageous with other database applications. Upon confirmation that the service parts are available, the order is released for picking. At pick release, the processing diverges with service parts order being electronically processed as the service parts are being physically picked at one or more warehouse locations. Processing converges again at the packout station where the service parts are packaged and shipping labels are printed. In a preferred embodiment, outbound and service parts return shipping labels are printed. The return shipping labels are placed in the package with the service parts for use in returning the parts, and outbound shipping labels are affixed to the package for shipment to the field service technician 14. As illustrated, Oracle provides input to many of the processes and receives input from the processes.

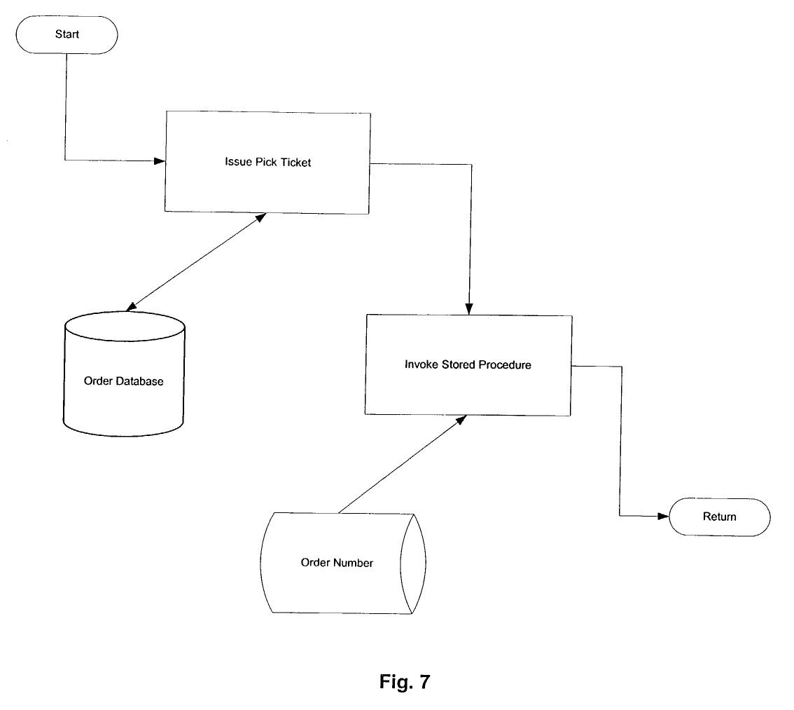

FIG. 7 illustrates that the service parts return system 10 processes are invoked by an Oracle stored procedure. The Oracle procedure invokes a service parts stored procedure that resides in Oracle. In a preferred embodiment, the service parts stored procedure receives an order number from the service parts order data as its input.

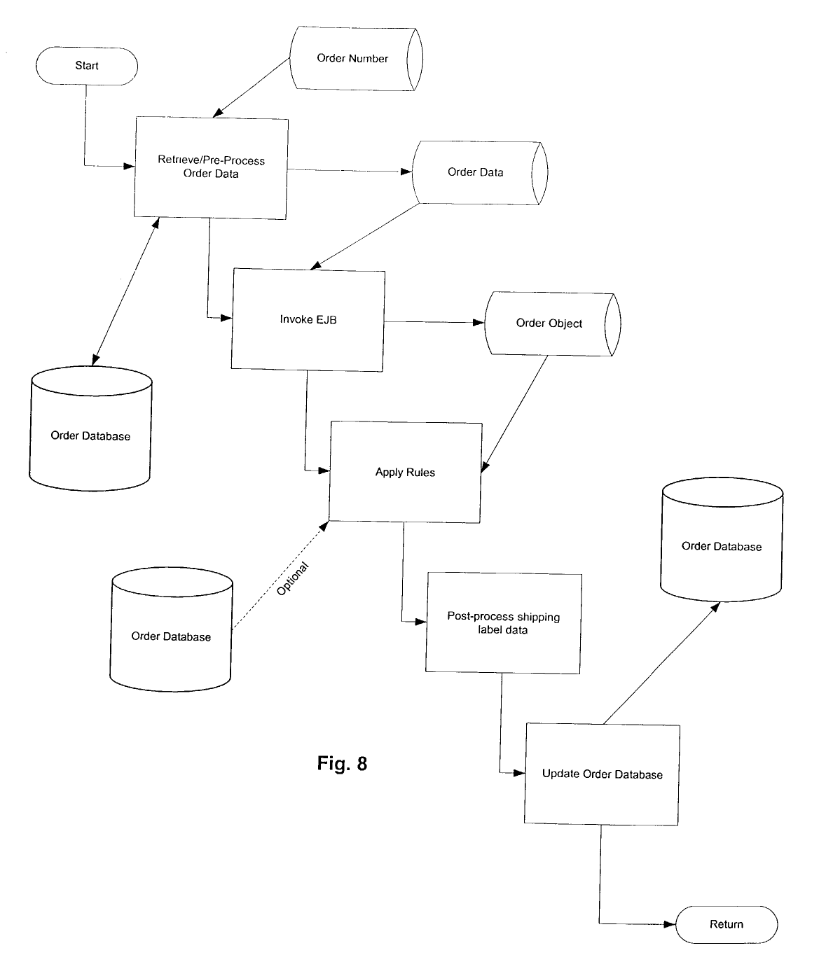

FIG. 8 illustrates the process beginning from within the service parts stored procedure where order data is retrieved from Oracle using the order number passed as a parameter. The order data is pre-processed to identify the origin and destination zones for later use when the rules are applied. The data is then packaged and used to instantiate the EJB that serves as the rules processing engine. In a preferred embodiment, this instantiation of the EJB is via a java stored procedure (JSP) with the bean invoked on the rules server, which may or may not be remote to the Oracle instance invoking it.

Once instantiated the bean applies the designated rules to the service parts order data passed in, and additional Oracle data can be retrieved if necessary to complete the rules processing. After processing the order data against the rules, the EJB returns the shipping label data to the calling service parts stored procedure where post-processing occurs and Oracle is updated with the shipping label data.

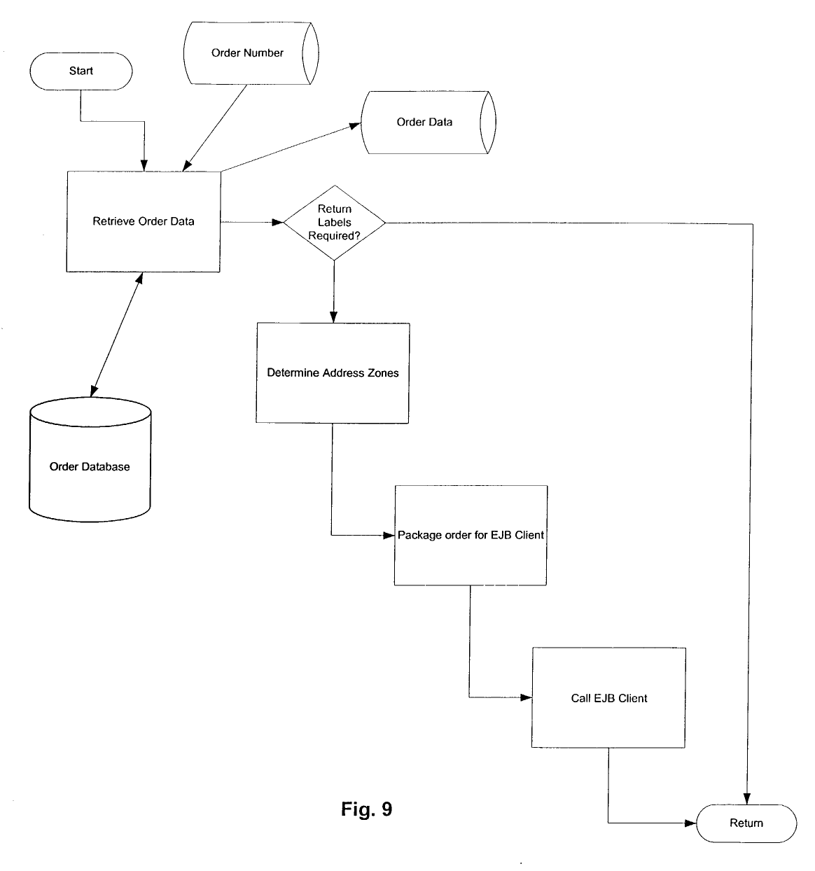

FIG. 9 illustrates a retrieval and pre-processing operation in accordance with an embodiment of the present invention. As described above, service parts order data is retrieved from Oracle using the order number and passed from an Oracle pick release stored procedure. In a preferred embodiment, the retrieved data includes both header and line data as well as attributes of service parts. If the user whose order is being processed utilizes the idea of zones, then zones associated with the ship to and ship from addresses are determined. This updated data is then prepared in arrays for submission to the EJB via an EJB client.

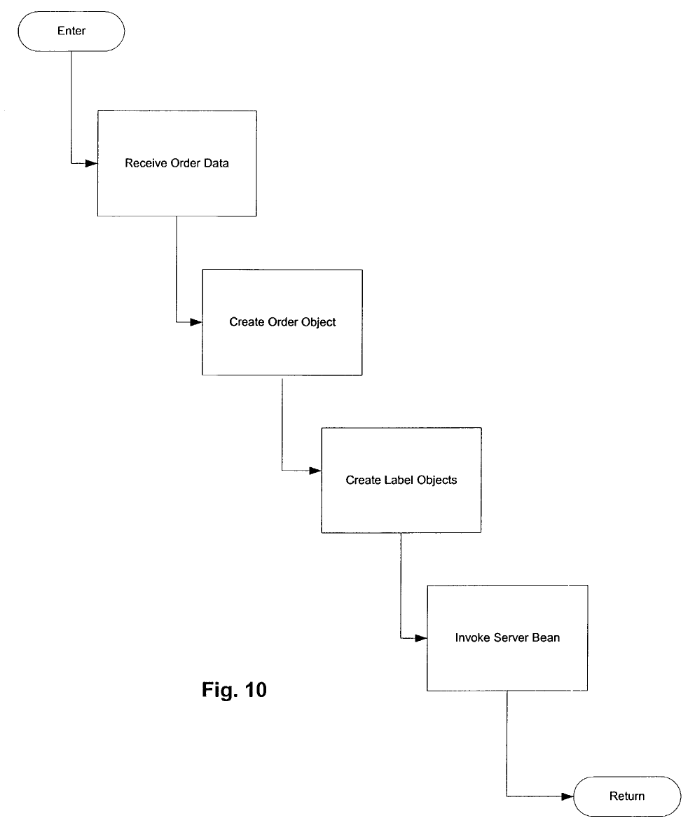

FIG. 10 illustrates the invocation of the EJB client. In a preferred embodiment, the EJB client is a Java client that is implemented on the Oracle RDBMS system. The EJB client receives the arrays of service parts order data, creates a Java order object suitable for processing by the rules engine 24 and passes that object to the rules engine 24. Following the application of the rules to the order data, the EJB client returns the order data to the calling Oracle stored procedure again via the arrays used to pass the data initially. In this embodiment, among the arrays that are passed back to the Oracle procedure is a new array that includes shipping label data, which is the result of the rules processing.

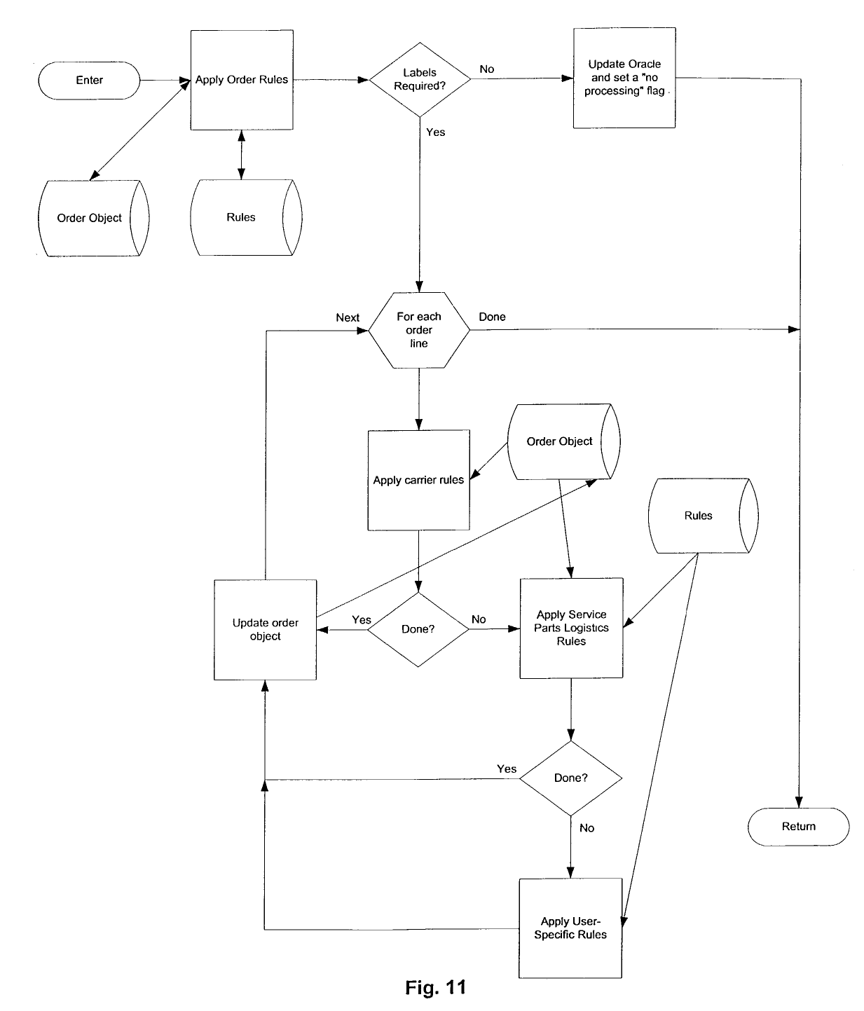

FIG. 11 illustrates the application of rules in accordance with an embodiment of the present invention. The application of rules is hierarchical in two ways, the order is examined at the header level first and, if necessary, at the line level. Initial rules look at the order header data to determine if service parts processing is require. If processing is not required, the order is flagged as having been processed but not requiring service parts shipping labels.

If the order data indicates that service parts processing is required each order line is processed. Carrier rules are applied for each. Carrier rules are sets of carrier-specific rules that a carrier applies to packages shipped in its system. Carrier rules can include, for example, a requirement that ground transportation be used for package shipments to or from certain locations. In the context of a service parts return system 10, a carrier may require that service parts transactions be available only in certain areas or under certain conditions.

If the carrier rules processing indicates that no service part shipping labels should be created for this line item, the local order data is updated and the next order line item is processed. Assuming that the carrier rules do not preclude the generation of service parts return shipping labels, service part logistics rules are applied. Service part logistics rules can vary from carrier to carrier. In a preferred embodiment, the service part logistics rules include a check to confirm that the customer that generated the service order request has a valid billing account number. As will be readily apparent to one of ordinary skill in the art, additional checks may be performed in this step based on the user and/or the service parts order information.

In a preferred embodiment, one or both of the carrier rules and service part logistics rules may indicate that service parts shipping labels should not be generated for a given line item. Assuming neither the carrier or service part logistic rules preclude the creation of service parts shipping labels, the order line data is updated and user-specific rules are applied to the order line.

Each order line is processed according to the foregoing steps. When all order lines have been processed, the EJB returns the updated order data for use in populating Oracle with the shipping label data. This data is returned to the EJB client where it is packaged and returned to the service parts stored procedure.

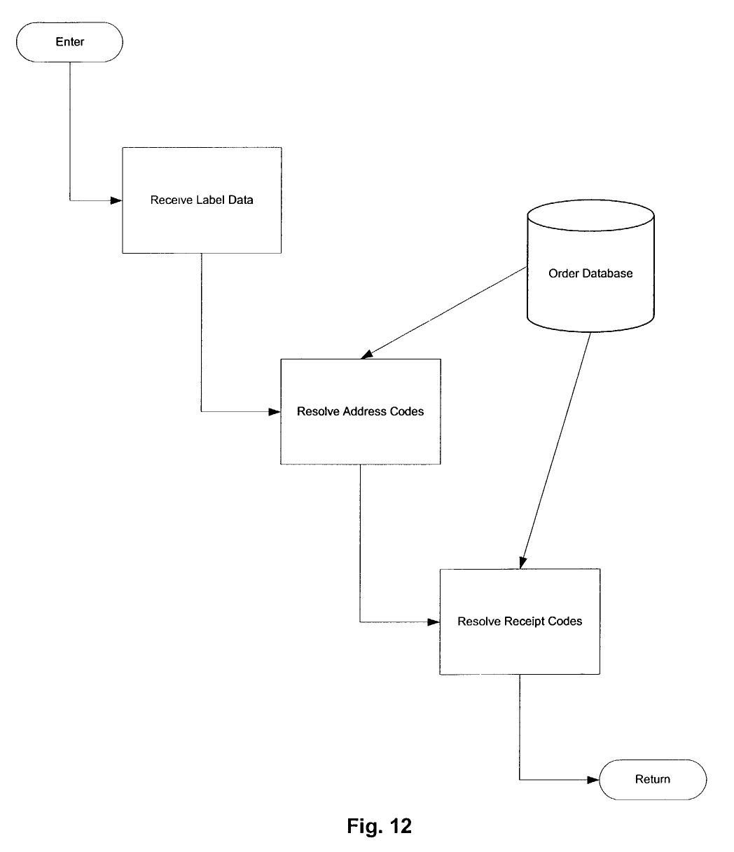

FIG. 12 illustrates the process of receiving and processing the order object/data in preparation for updating the Oracle database. In a preferred embodiment, post-process shipping label data identifies the need to resolve address and receipt codes populated by the rules engine 24. These codes are used as the key to look in the Oracle locations for complete address information and to determine what data will populate the user-defines areas of the service parts shipping label. The address and receipt information is used to populate a service parts shipping label table.

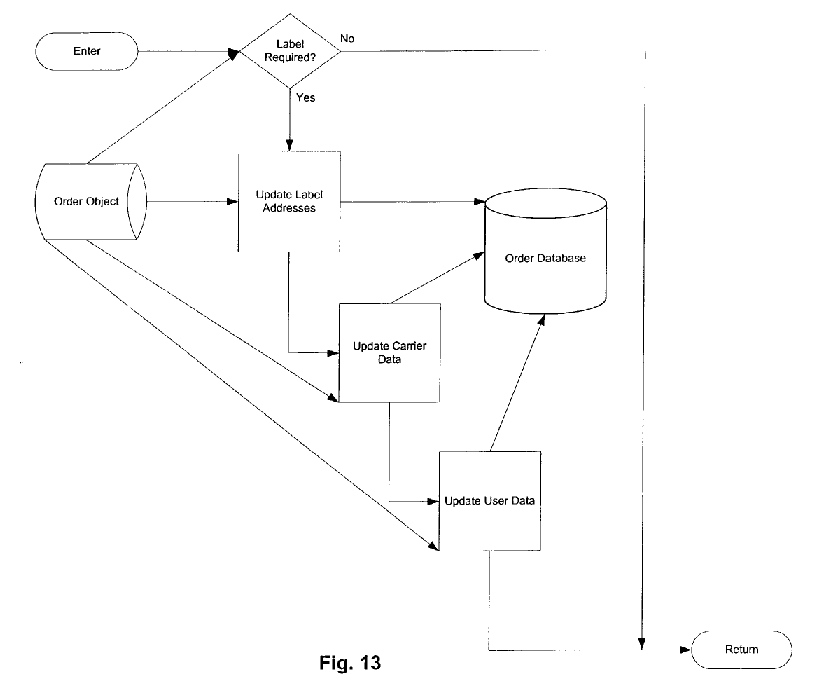

FIG. 13 illustrates the process of updating Oracle in accordance with an embodiment of the present invention. In a preferred embodiment, the Oracle database is updated with three types of data, including the address data, carrier data such as service level and reference fields, and user-specific reference values. Also in the preferred embodiment, all of these data elements are stored in a service parts label data table.

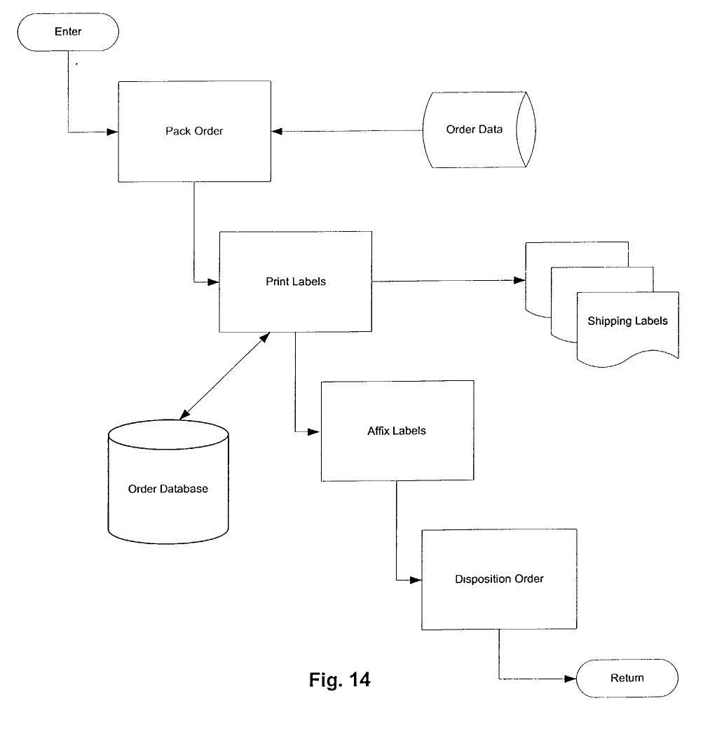

FIG. 14 illustrates the steps of a pick and ship order process. This process occurs at the distribution centers and field stocking locations where the service parts are stored. When an order is received at the warehouse, the referenced service parts are picked from storage and packaged for shipment. As part of the parallel processes described above, outbound and service part return shipping labels are generated and printed at the packout station within the warehouse. Service part return shipping labels are placed in the package with the service parts. Outbound shipping labels are affixed to the packages and the package is dispositioned.

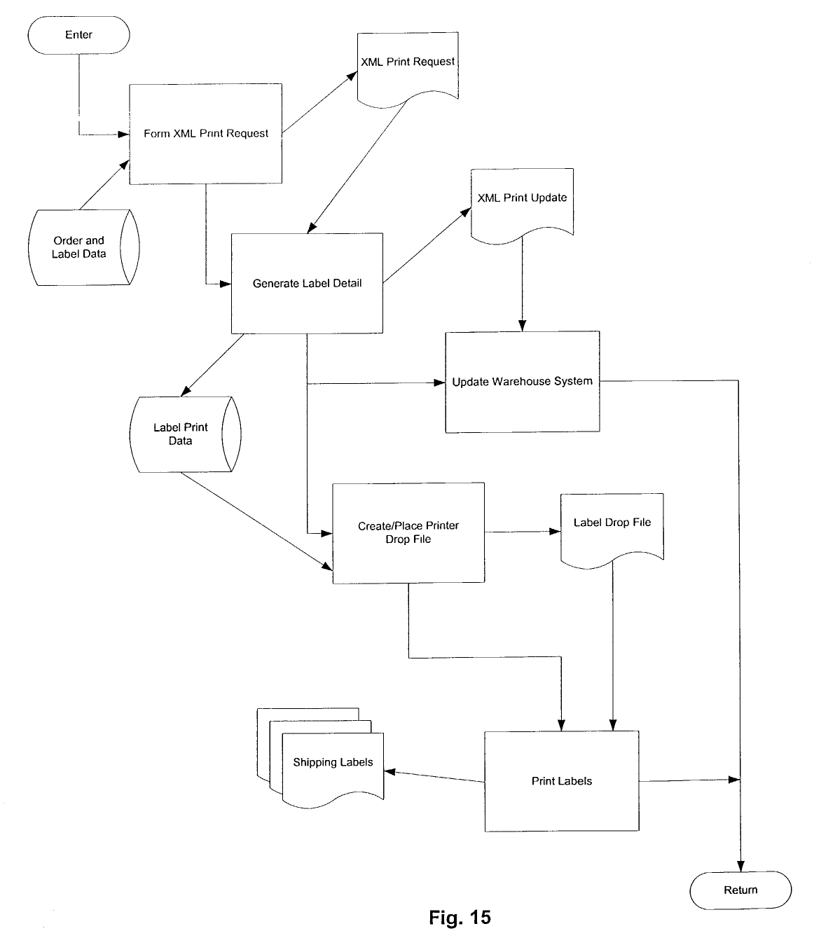

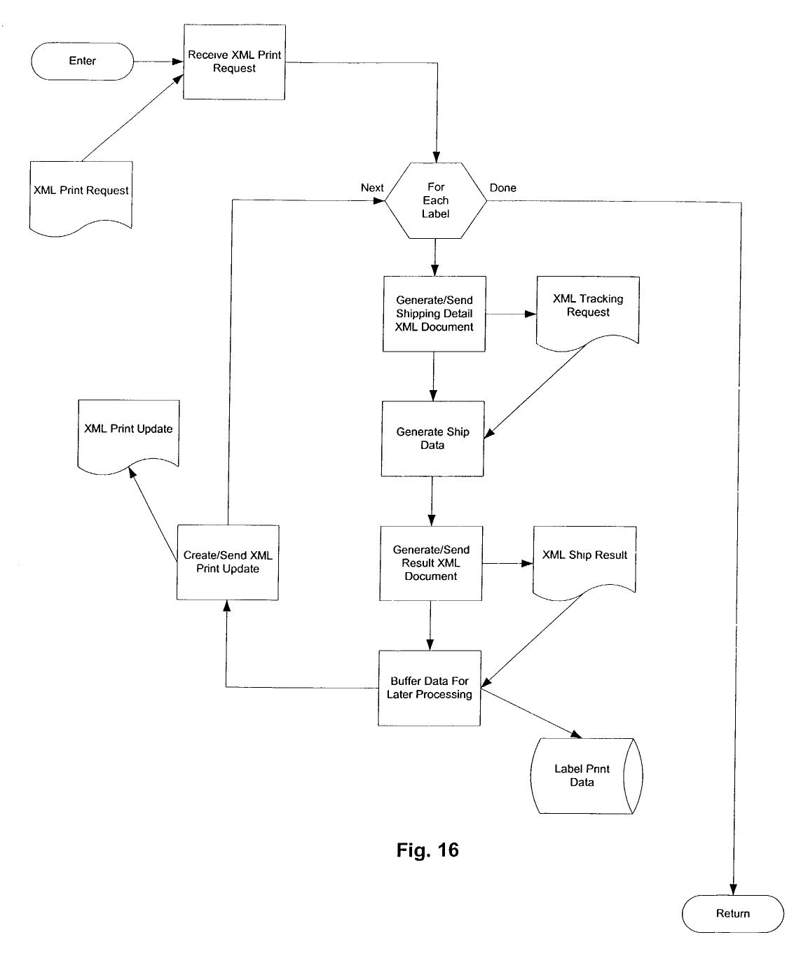

The process of printing the shipping labels is illustrated in FIGS. 15 and 16. The process occurs at the packout station of a distribution center or field stocking location. In a preferred embodiment, a warehouse employee initiates the process by activating a “ship” button (or analogous name) on a warehouse management server interface, which generates an XML print request document. This document is delivered via MQ Series and is processed mid-stream by MQSI. The XML data is then sent to the carrier shipping system 55 and the resulting ship data is returned to the warehouse management server 65 and updates the Oracle database. The update sent to the warehouse management server 65 is also via MQ Series as an XML document. In a preferred embodiment, the ship data returned from the carrier shipping system 55 is used to create a printer drop file. The drop file is subsequently deposited in the proper directory such that shipping labels are printed on an associated printer.

In a preferred embodiment, the ship request document received by MQSI contains data necessary to print both the outbound and service parts return shipping labels. MQSI parses the data and creates an XML document for each shipping label. These documents are identified as XML tracking request documents in FIG. 16. Each XML tracking request document is then sent to the carrier shipping system 55, which generates shipping data, including a package tracking number and routing code. The carrier shipping system 55 then formats the shipping data as an XML ship request document, which is returned to MQSI. MSQI buffers the XML ship request document and uses it to create a printer drop file. In addition, MQSI formats an XML print update document that is used to update the warehouse management server 65 with the new shipping detail. When all of the shipping label data has been processed, the data used to create the printer drop file is stored in memory.

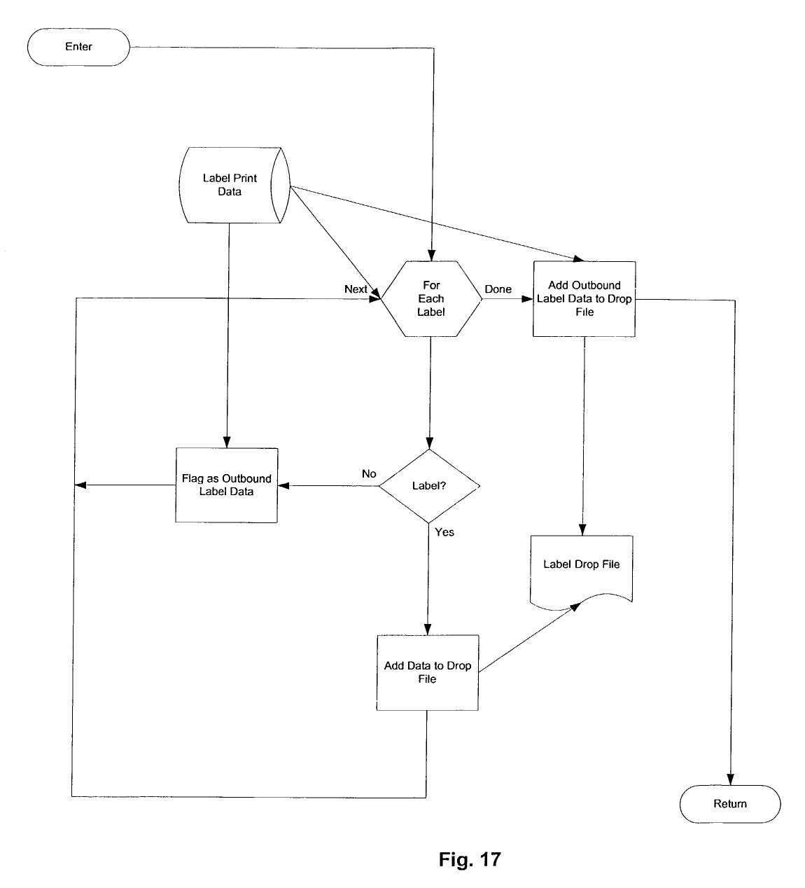

FIG. 17 illustrates the process required to create a printer drop file. In a preferred embodiment, the creation of a printer drop file requires iterating the shipping label data buffered in memory. Each time shipping label data is encountered it is written to the printer drop file in the proper format. In this embodiment, the outbound label data is passed over until the end at which time it too is written to the printer drop file. The outbound label is saved until the last pass so that the outbound shipping label serves as an indicator to warehouse personnel that the last label for a given package has completed printing.

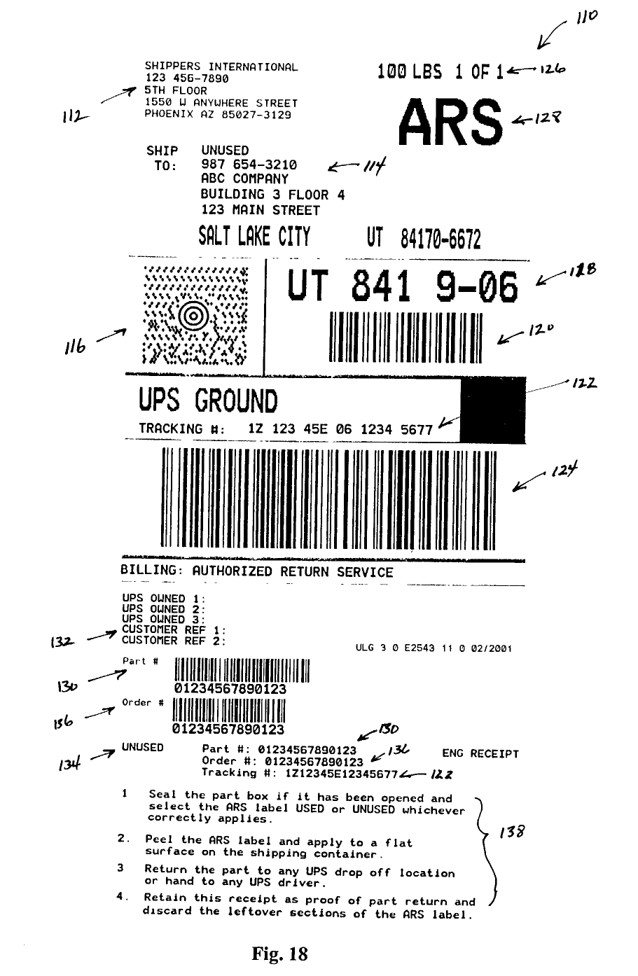

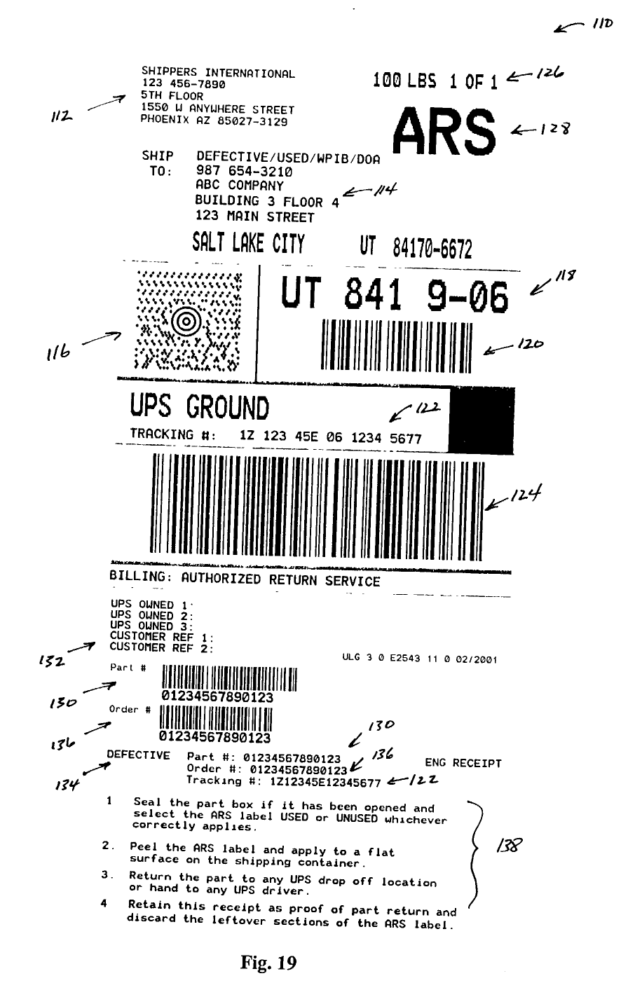

FIGS. 18 and 19 illustrate service parts return shipping labels 110 in accordance with an embodiment of the present invention. Each shipping label 110 includes a ship from address 112, ship to address 114, Maxicode™ 116, post office code 118, post office bar code 120, package tracking number 122, carrier bar code 124, package weight 126 and service level identifier 128. The shipping label also includes specific fields that identify the label as part of a service parts return system 10. These fields include a part number 130, a customer reference field 132, a service part condition identifier 134, order number 136 one or more user-customizable areas 138.

In a preferred embodiment, the part number 130 identifies the service part that the field service technician 14 is shipping and the service part condition identifier 134 indicates whether the part is used or unused. In the case of a used part, the ship to address 114 may be that of the manufacturer, part supplier or other entity prepared to receive and handle used parts. In one embodiment, the handling of used parts is based at least in part on the part number 130. For example, a first used part may be shipped to a facility to be repaired, while a second used part is shipped to a salvage area, and a third used part shipped to a disposal location. In one embodiment, service parts identified as unused in the condition identifier area 134 may be returned to the distribution center or field stocking location from which they originated or, alternatively, to a warehouse location that has a low inventory for that part.

The customer reference fields 132 of a service part return shipping label 110 can include one or all of an order number, part number, outbound package tracking number, or disposition number. Because the customer reference field 132 is user customizable, the information used to populate the field can differ from user to user and may include any additional information that a manufacturer 12 or other customer requests to be placed on a shipping label.

In addition, a plurality of user-customizable fields 138 is included on the bottom of the shipping label 110. These fields 138 may include any additional information that a user wishes to be placed on the label. For example, a service part may be especially fragile and these fields may include special packing instructions whenever a shipping label is generated for the part. Alternatively, the user-customizable fields 138 may instruct the field service technician 14 on when and how to use the various shipping labels included with the service parts. One of ordinary skill in the art will readily recognize that individuals users may have specialized needs for these customizable fields 138 and that these needs are intended to be encompassed by the present invention.

In a preferred embodiment, a field service technician that receives service parts for a repair receives the shipping labels 110 illustrated in FIGS. 18 and 19. Because the shipping labels 110 are alternative shipping labels for returning the same service part, many of the label fields will use the same information, including without limitation the part number, customer reference number, ship from address, package weight, service level and RCV reference number. In a preferred embodiment, the labels 110 have different package tracking numbers, which allows the carrier to identify which of the shipping labels is used for the return. In a preferred embodiment, the package tracking number is scanned by the carrier when the package is accepted and the package tracking number is compared against one or more service parts tracking numbers to identify the shipping label and contents of the package. This information thus becomes available to carrier customers and provides them with added visibility about service parts in transit, thus providing for increased accuracy and efficiency in parts inventory and timely billing initiation.

The shipping label 110 of FIG. 18 is used to return a service part that is not used in the repair. In this illustration, the condition identifier 134 and the ship to address 114 of the label identify the part as unused. Moreover, the user-customizable areas 138 of the label 110 provide the field service technician with instructions as to how and when to use the ARS label. In one embodiment, the ship from address may be the address of the originating warehouse for the service part. Alternatively, the ship to address may be an address of a location that is equipped to receive unused parts and/or a location that has a shortage of that particular service part. In a preferred embodiment, the field service technician also receives the shipping label 110 illustrated in FIG. 19. In this example, the field service technician uses the shipping label of FIG. 19 if the part is defective, used, the wrong part in the box, or dead on arrival. In alternative embodiments, additional shipping labels may be used for some or all of these different situations.

The service parts return system 10, which comprises an ordered listing of selectable services can be embodied in any computer-readable medium for use by or in connection with an instruction execution system, apparatus, or device, such as a computer-based system. processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Further, any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

It should be emphasized that the above-described embodiments of the present invention, particularly any “preferred embodiments” are merely possible examples of the implementations, merely set forth for a clear understanding of the principles of the invention. Any variations and modifications may be made to the above-described embodiments of the invention without departing substantially from the spirit of the principles of the invention. All such modifications and variations are intended to be included herein within the scope of the disclosure and present invention and protected by the following claims.

In concluding the detailed description, it should be noted that it will be obvious to those skilled in the art that many variations and modifications can be made to the preferred embodiment without substantially departing from the principles of the present invention. Also, such variations and modifications are intended to be included herein within the scope of the present invention as set forth in the appended claims. Further, in the claims hereafter, the structures, materials, acts and equivalents of all means or step-plus function elements are intended to include any structure, materials or acts for performing their cited functions.

That which is claimed:

1. A method of providing at least one service part to a field technician, said method comprising the steps of:
receiving an order to ship a part to said field technician, said order including a part identifier associated with said part;
querying a parts database with said part identifier to identify a warehouse that has said part in stock;
processing said order against a rules engine to associate an outbound shipping label and at least one return shipping label to said order, and to generate shipping label data for said outbound shipping label and for said at least one return shipping label;
printing said outbound shipping label and said at least one return shipping label at said warehouse;
enclosing said at least one return shipping label within a package along with said part;
affixing said outbound shipping label to said package; and
shipping said package to said field technician.

2. The method of claim 1, wherein the step of receiving an order comprises receiving an order from said field technician.

3. The method of claim 1, wherein the step of receiving an order comprises receiving an order from an employer of said field technician.

4. The method of claim 1, wherein the step of receiving an order comprises receiving an order from an order entry system.

5. The method of claim 1, wherein the step of receiving an order comprises receiving an order via electronic data interchange.

6. The method of claim 1, wherein the step of receiving an order comprises receiving an order via electronic mail.

7. The method of claim 1, wherein the step of receiving an order comprises receiving an order via a facsimile or phone call to a customer service representative that enters the order into an order entry system.

8. The method of claim 1, wherein said part identifier included in said order is a part number.

9. The method of claim 1, wherein the step of querying a parts database to identify a warehouse comprises querying a parts database to determine whether said part is available and, if available, where said part is located.

10. The method of claim 1, wherein the step of querying a parts database to identify a warehouse comprises the steps of:
identifying a warehouse that has said part in stock;
setting a flag in said parts database to reserve said part; and
contacting said warehouse to have said part picked for shipment.

11. The method of claim 1, wherein the step of querying a parts database to identify a warehouse comprises querying a parts database to determine whether said part is available and, if not available, backordering said part.

12. The method of claim 1, wherein the step of processing said order against a rules engine comprises the steps of:
converting said order into an order array for submission to an enterprise Java bean via an enterprise Java bean client;
receiving said order array into said enterprise Java bean;
creating a Java order object suitable for processing by said rules engine; and
passing said order object to said rules engine.

13. The method of claim 1, wherein the step of processing said order against a rules engine comprises applying at least one of carrier rules, logistics rules and user-defined rules to said order.

14. The method of claim 1, wherein the step of generating shipping label data for said at least one return shipping label comprises generating label data for a first and second return shipping label, said first return shipping label identifying a returned part as used, and said second return shipping label identifying said returned part as unused.

15. The method of claim 1, wherein the step of generating shipping label data for said at least one return shipping label comprises generating data for a return shipping label used to return said part to said warehouse.

16. The method of claim 1, wherein the step of generating shipping label data for said at least one return shipping label comprises generating data for a shipping label that will allow said field technician to return said part to said warehouse.

17. The method of claim 1, wherein the step of generating shipping label data for at least one return shipping label comprises generating data for a shipping label that designates said warehouse as a destination address of said shipping label.

18. The method of claim 1, wherein the step of generating shipping label data for said at least one return shipping label comprises generating data for shipping labels that allow said field technician to ship a used part for at least one of repair, restocking, salvage and disposal.

19. The method of claim 1, wherein the step of printing said outbound label and said at least one return shipping label at said warehouse comprises:
transmitting said shipping label data in an electronic format to a printing device located at said warehouse; and
printing said outbound label and said at least one return shipping labels on said printing device, wherein the information printed on said shipping labels is based at least in part on said shipping label data.

20. The method of claim 1, wherein the step of printing said outbound label and said at least one return shipping label at said warehouse comprises:
transmitting said shipping label data in an electronic format to a computer system associated with said warehouse;
forwarding said shipping label data to a carrier application upon a manual activation of said warehouse computer system;
assigning a package tracking number to said outbound shipping label and each of said one or more shipping labels;
generating said outbound shipping label and said at least one return shipping label based at least in part on said shipping label data; and
printing said outbound shipping label and said at least one return shipping label at said warehouse.

21. The method of claim 1, further comprising the step of assigning a package tracking number to said outbound shipping label and to said at least one return shipping label.

22. The method of claim 1, wherein the step of enclosing said at least one return shipping labels in a package with said part comprises the steps of:
picking said part from a storage area within said warehouse;
placing said part in a package;
retrieving said at least one return shipping label from a printing device; and
enclosing said at least one return shipping label in said package.

23. A service parts shipping system, said system comprising:
an order entry application, said order entry application configured to receive order data from a user, said order data including at least one service part number;
a parts management application in electronic communication with said order entry application, said parts management application configured to receive said order data and query a parts database with said service part number to determine an availability of a service part;
a rules engine in electronic communication with at least one of said order entry system and said parts management application, said rules engine configured to receive said order data and process said order data against at least one rule; said rules engine further configured to generate shipping label data based at least in part on said at least one rule; and
a printing device configured to print at least one shipping label based at least in part on said shipping label data.

24. The system of claim 23, wherein said order entry application is configured to receive order data from a field technician.

25. The system of claim 23, wherein said order entry application is configured to receive order data from a customer service representative, said customer service representative in contact with a field technician.

26. The system of claim 23, wherein said order entry application is configured to receive order data from a user via electronic data interchange.

27. The system of claim 23, wherein said order entry application is configured to receive order data from a user via at least one of electronic mail, facsimile and phone.

28. The system of claim 23, wherein said part identifier is a service part number.

29. The system of claim 23, wherein said parts management application is further configured to identify a warehouse that has said service part in stock.

30. The system of claim 23, wherein said parts management application is further configured to reserve said service part.

31. The system of claim 23, wherein said parts management application is further configured to backorder a service part that is unavailable.

32. The system of claim 23, wherein said rules engine receives said order data from said order entry application.

33. The system of claim 23, wherein said rules engine receives said order data from said parts management system.

34. The system of claim 23, wherein said rules engine is configured to process said order data against at least one of a carrier rule, a logistics rule and a user-defined rule.

35. The system of claim 23, wherein said rules engine is configured to generate shipping label data for an outbound shipping label and a return shipping label.

36. The system of claim 23, wherein said rules engine is configured to generate shipping label data for a first and second return shipping label, said first return shipping label identifying a returned part as used, and said second return shipping label identifying said returned part as unused.

37. The system of claim 23, wherein said rules engine is configured to generate shipping label data for return shipping labels that allow a field technician to ship a used part for at least one of repair, restocking, salvage and disposal.

38. The system of claim 23, wherein said printing device receives said shipping label data from said rules engine.

39. The system of claim 23, wherein said printing device receives said shipping label data from one of said order entry application and said parts management application.

40. The system of claim 23, further comprising:
a warehouse application, said warehouse application configured to receive said shipping label data, said warehouse application further configured to transmits said shipping label data to a carrier system and receive a shipping label image from said carrier system; and
a shipping label generation application residing on said carrier system, said shipping label generation application configured to receive said shipping label data and generate said shipping label image.

41. The system of claim 40, wherein said printing device is located at said warehouse.

42. The system of claim 40, wherein said shipping label application is further configured to transmit said shipping label image to said printing device, and said shipping label printed by said printing device is based at least in part on said shipping label image.

43. The system of claim 40, wherein said warehouse application is further configured to receive said shipping label image and send said shipping label image to said printing device.

44. A method of monitoring the status of service parts that are shipped to a field technician, the method comprising the steps of:
receiving a service parts request, said service parts request including a request to ship a service part to a field technician;
generating an outbound shipping label and a return shipping label in response to said service parts request;
assigning a first service part tracking number to said outbound shipping label and a second service part tracking number to said return shipping label;
storing information about said service parts request in a service parts transaction database, said stored information including said first and second service part tracking numbers;
capturing package level detail information about a package that is shipped through a carrier, said package level detail information including a package shipment status and a package tracking number associated with said package; and
updating said service parts transaction database with said package level detail information when said package tracking number corresponds to said first or second service parts tracking numbers.
